(19) United States
(12) Patent Application Publication
(10) Pub. No.: US 2006/0207815 A1
(43) Pub. Date: Sep. 21, 2006

(54) Condenser arrangement

(75) Inventor: Nathan Vandekerkhof, Clinton Twp, MI (US)

Correspondence Address: GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills, MI (US)

(21) Appl. No.: 11/081,674

(22) Filed: Mar. 17, 2005

(51) Int. Cl. B60K 11/04

(52) U.S. Cl. 180/68.4

(57) ABSTRACT

A condenser arrangement for a vehicle is provided that comprises a vehicle support structure, upper and lower condenser coupling structures and a condenser. The upper and lower condenser coupling structures are fixedly coupled to upper and lower mounting portions of the vehicle support structure. The condenser has a lower attachment structure releasably engaged with the lower condenser coupling structure, and an upper attachment structure releasably engaged with the upper condenser coupling structure. The upper and lower condenser coupling structures are configured and arranged with respect to the upper and lower attachment structures, respectively, to form a pair of toolless connections between the condenser and the vehicle support structure for repeatable connection and detachment of the condenser to and from the vehicle support structure with the toolless connections having retaining forces greater than vibrationally inducing forces occurring during operation of the vehicle.

### BACKGROUND OF THE INVENTION

1. Field of the Invention

The present invention generally relates to a condenser arrangement for a vehicle. More specifically, the present invention relates to a condenser mounting structure in which a condenser is mounted to a vehicle support structure with a plurality of toolless connections.

2. Background Information

In some conventional condenser arrangements that are utilized in a vehicle, a condenser is mounted to a vehicle support structure by using a pair of upper brackets and a pair of lower brackets. More specifically, the upper and lower brackets are attached to a radiator core support member or a bolster member of the vehicle support structure. The lower brackets are usually mounted to the radiator core support member using spot weld since the lower brackets usually do not need to be removed for disassembly and assembly of the condenser for service. On the other hand, the upper brackets are usually attached by using fasteners or the like so that they can be installed and removed repeatedly.

When the condenser is mounted to the radiator core support member in such conventional condenser arrangement, first, two lower pins of the condenser are inserted into openings in the lower brackets that are fixedly coupled to the radiator core support member. Then, the upper brackets are attached to a pair of upper pins of the condenser. Finally, the upper brackets are attached to the radiator core support member by the fasteners. In order to dismantle the condenser from the radiator core support member for service, this operation is done in a reverse order. In other words, in order to dismantle the condenser from the radiator core support member, the upper brackets need to be detached from the radiator core support member by disengaging the fasteners.

The conventional condenser arrangement is time consuming for mounting and detaching the condenser from the vehicle support structure for assembly and service. Also, this type of conventional condenser arrangement limits the design capabilities of the front end portion of the vehicle because the upper brackets, which are attached to the vehicle support structure by the fasteners, have to be designed to provide sufficient strength.

In view of the above, it will be apparent to those skilled in the art from this disclosure that there exists a need for an improved condenser arrangement for a vehicle. This invention addresses this need in the art as well as other needs, which will become apparent to those skilled in the art from this disclosure.

### SUMMARY OF THE INVENTION

One object of the present invention is to provide a condenser arrangement for a vehicle in which the condenser is easily and quickly mounted to and detached from a vehicle support structure without using a fastening tool.

In order to achieve the above mentioned object and other objects of the present invention, a condenser arrangement for a vehicle is provided that comprises a vehicle support structure, a lower condenser coupling structure, an upper condenser coupling structure, and a condenser. The vehicle support structure has a bottom mounting portion and an upper mounting portion. The lower condenser coupling structure is fixedly coupled to the bottom mounting portion of the vehicle support structure. The upper condenser coupling structure is fixedly coupled to the upper mounting portion of the vehicle support structure. The condenser has a lower attachment structure and an upper attachment structure. The lower attachment structure is disposed at a bottom portion of the condenser that is releasably engaged with the lower condenser coupling structure of the vehicle support structure. The upper attachment structure is disposed at an upper portion of the condenser that is releasably engaged with the upper condenser coupling structure of the vehicle support structure. The upper and lower condenser coupling structures are configured and arranged with respect to the upper and lower attachment structures, respectively, to form a pair of toolless connections between the condenser and the vehicle support structure for repeatable connection and detachment of the condenser to and from the vehicle support structure with the toolless connections having retaining forces greater than vibrationally inducing forces occurring during operation of the vehicle.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a front perspective view of a condenser arrangement in accordance with a first embodiment of the present invention;

FIG. 2 is an exploded front perspective view of the condenser arrangement illustrated in FIG. 1 including a condenser and a vehicle support structure in accordance with the first embodiment of the present invention;

FIG. 3 is a cross sectional view of the condenser arrangement as taken along section line 3-3 in FIG. 1;

FIG. 4 is an enlarged partial perspective view of an attachment structure of the vehicle support structure, an upper condenser bracket and an upper pin of the condenser in the condenser arrangement in accordance with the first embodiment of the present invention;

FIG. 5 is a cross sectional view of the attachment structure of the upper condenser bracket and the upper pin of the condenser in the condenser arrangement in accordance with the first embodiment of the present invention;

FIG. 6 is an enlarged exploded perspective view of the vehicle support structure, the upper condenser bracket and the upper pin of the condenser in accordance with the first embodiment of the present invention;

FIG. 7 is an enlarged rear perspective view of the upper condenser bracket used in the condenser arrangement in accordance with the first embodiment of the present invention;

FIG. 8 is an enlarged side elevational view of the upper condenser bracket used in the condenser arrangement in accordance with the first embodiment of the present invention;

FIG. 9(a) is an exploded top plan view of the upper condenser bracket and the upper pin of the condenser for the condenser arrangement in accordance with the first embodiment of the present invention;

FIG. 9(b) is a side elevational view of the upper condenser bracket and the upper pin of the condenser for the condenser arrangement in accordance with the first embodiment of the present invention;

FIG. 10 is a series of diagrams illustrating an assembly process in which the condenser is mounted to the vehicle support structure in the condenser arrangement in accordance with the first embodiment of the present invention;

FIG. 11(a) is a cross sectional view of a first modified condenser arrangement with first modified mounting structures of the upper condenser bracket and the vehicle support structure for the condenser arrangement in accordance with the present invention;

FIG. 11(b) is a cross sectional view of a second modified condenser arrangement with second modified mounting structures of the upper condenser bracket and the vehicle support structure for the condenser arrangement in accordance with the present invention;

FIG. 12 is a front perspective view of a condenser arrangement in accordance with another embodiment of the present invention; and

FIG. 13 is a cross sectional view of the condenser arrangement as taken along section line 13-13 in FIG. 12 in accordance with the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

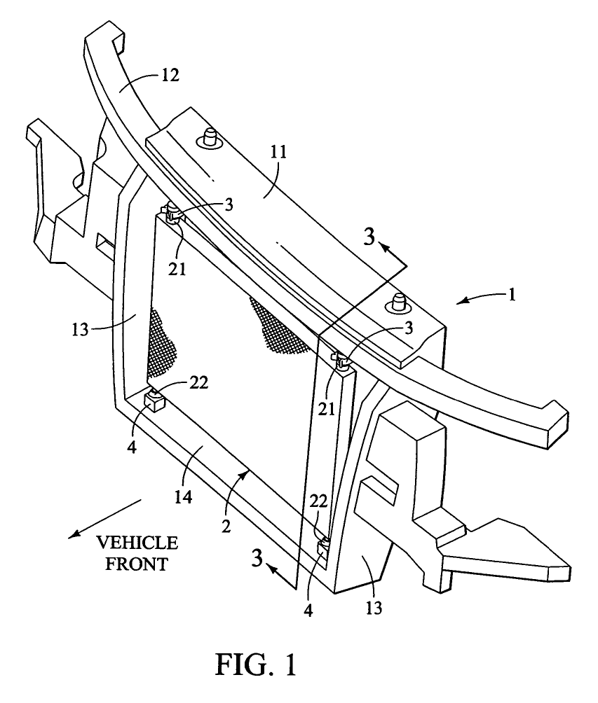

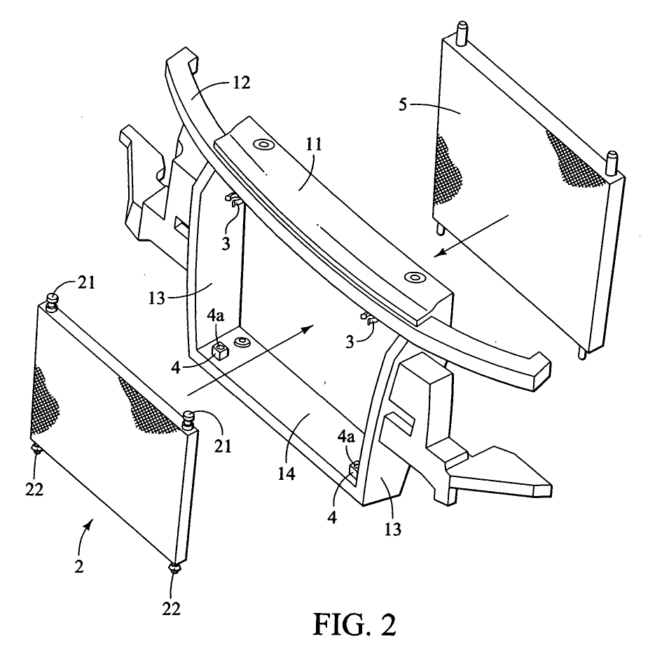

Referring initially to FIGS. 1 and 2, a condenser arrangement is illustrated in accordance with a preferred embodiment of the present invention. As seen in FIGS. 1 and 2, the condenser arrangement of this embodiment is preferably incorporated in a vehicle front end module that is configured and arranged to be disposed in a front portion of a vehicle. The vehicle front end module includes a vehicle support structure 1 that constitutes the framework configured and arranged to incorporate a plurality of brackets for mounting various vehicle components that are disposed in the front end portion of the vehicle.

As seen in FIGS. 1 and 2, the vehicle support structure 1 basically includes an upper radiator bracket 11, an upper bolster member 12, a pair of side frame members 13 and a lower bolster member 14. The upper radiator bracket 11 and the upper bolster member 12 both extend in a top portion of the vehicle support structure 1 in a generally transverse direction of the vehicle. The upper bolster member 12 is disposed in a front side of the vehicle with respect to the upper radiator bracket 11, and preferably fixedly coupled to the upper radiator bracket 11. The lower bolster member 14 extends in a bottom portion of the vehicle support structure 1 in the generally transverse direction of the vehicle. The side frame members 13 connect transverse edges of the upper radiator bracket 11 and the lower bolster member 14 thereby forming an enclosed frame structure in a center portion of the vehicle support structure 1. The upper radiator bracket 11 and/or the upper bolster member 12 constitute(s) an upper mounting portion of the vehicle support structure 1, and the lower bolster member 14 constitutes a lower mounting portion of the vehicle support structure 1.

In this embodiment of the present invention, the vehicle support structure 1 is preferably made of metallic material such as steel by stamping sheet metals to form the upper radiator bracket 11, the upper bolster member 12, the side frame members 13 and the lower bolster member 14. Alternatively, the vehicle support structure 1 can be formed with composite material (as hybrid of metal and plastic) by, for example, providing metal reinforcement members which are surrounded by molded plastic members. Of course, it will be apparent to those skilled in the art from this disclosure that the precise structure of the vehicle support structure 1 can vary depending on various design considerations of the vehicle. In other words, the present invention can be applied to a wide variety of vehicle support structures.

As seen in FIGS. 1 and 2, a condenser 2 is preferably mounted to a front portion of the enclosed frame structure formed in the vehicle support structure 1. The condenser 2 is configured and arranged to turn refrigerant vapor into liquid to cause heat to be discharged from the refrigerant for an air conditioning system of the vehicle. The main body of the condenser 2 is basically a conventional component that is well known in the art. Since the condenser 2 is well known in the art, the precise structure of the condenser 2 will not be discussed or illustrated in detail herein, except for components of the condenser 2 that are related to the mounting structure of the condenser 2 to the vehicle support structure 1 in accordance with the present invention.

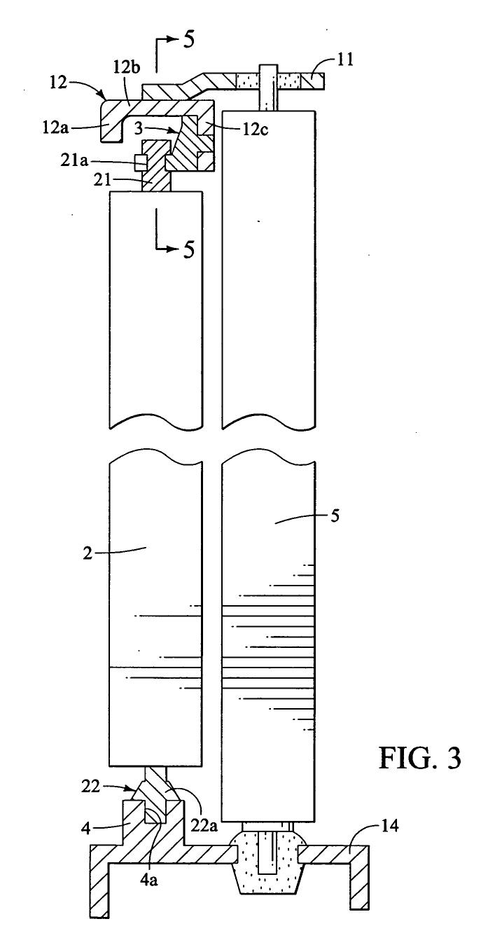

Also, as seen in FIGS. 2 and 3, a radiator 5 is mounted to the enclosed frame structure formed in the vehicle support structure 1 in the rear side with respect to the condenser 2. The radiator 5 is preferably coupled to the upper radiator bracket 11 and the lower bolster member 14 as seen in FIG. 3. However, the precise structure of the radiator 5 and mounting structure of the radiator 5 to the vehicle support structure 1 are not important in the present invention. Thus, these structures relating to the radiator 5 will not be discussed in detail herein.

In the condenser arrangement in accordance with the present invention, the condenser 2 is configured and arranged to be mounted to the vehicle support structure 1 by toolless connections formed between the condenser 2 and the vehicle support structure 1 for repeatable connection and detachment of the condenser 2 to and from the vehicle support structure 1. The toolless connections formed between the condenser 2 and the vehicle support structure 1 are configured and arranged to have retaining forces greater than vibrationally inducing forces occurring during operation of the vehicle. In other words, the vibration of the condenser 2 with respect to the vehicle support structure 1 will not result in the toolless connections being uncoupled during the vehicle is in operation. In the present invention, the toolless connections between the condenser 2 and the vehicle support structure 1 enables the condenser 2 to be easily mounted to and detached from the vehicle support structure 1 during assembly and service without using a fastening tool, which results in reduction of assembly time and time required for service.

In the present invention, the toolless connections between the condenser 2 and the vehicle support structure 1 are formed by coupling a lower attachment structure of the condenser 2 to an lower condenser coupling structure that is fixedly coupled to the lower bolster member 14 of the vehicle support structure 1, and by coupling an upper attachment structure of the condenser 2 to an upper condenser coupling structure that is fixedly coupled to the upper bolster member 14 of the vehicle support structure 1.

In this embodiment of the present invention, the upper attachment structure of the condenser 2 includes a pair of upper pins 21 and the lower attachment structure of the condenser 2 includes a pair of lower pins 22. The upper pins 21 protrude substantially upward direction on a top surface of the condenser 2, and are preferably spaced apart in the transverse direction of the vehicle as seen in FIG. 2. Each of the upper pins 21 is preferably provided with an annular engagement groove 21a formed on an outer circumferential surface of the upper pin 21. The lower pins 22 are formed on a bottom surface of the condenser 2 and protrude in a substantially downward direction. Similarly to the upper pins 21, the lower pins 22 are preferably spaced apart in the transverse direction of the vehicle. Each of the lower pins 22 preferably includes a flange 22a extending substantially radially from the lower pin 22 as seen in FIG. 3.

The upper condenser coupling structure includes a pair of upper condenser brackets 3 that are fixedly coupled to the upper bolster member 12 of the vehicle support structure 1. More specifically, as seen in FIG. 3, the upper bolster member 12 includes a front vertical part 12a, a rear vertical part 12c and an upper horizontal part 12b that extends between upper edges of the front and rear vertical parts 12a and 12c. The upper condenser brackets 3 are disposed in the rear vertical part 12c of the upper bolster member 12 in positions that correspond to the positions of the upper pins 21 of the condenser 2 when the condenser 2 is coupled to the vehicle support structure 1. As mentioned above, the upper pins 21 of the condenser 2 and the upper condenser brackets 3 are configured and arranged to be releasably coupled together without using a fastening tool as discussed in more detail below. The front vertical part 12a of the upper bolster member 12 is arranged with respect to the upper condenser brackets 3 so that the front vertical part 12a does not interfere with the upper pins 21 of the condenser 2 when the upper pins 21 are attached to or disengaged from the upper condenser brackets 3.

The lower condenser coupling structure includes a pair of lower condenser brackets 4 that are fixedly coupled to the lower bolster member 14 of the vehicle support structure 1. The lower condenser brackets 4 are disposed in the lower bolster member 14 in positions that correspond to the positions of the lower pins 22 of the condenser 2 when the condenser 2 is coupled to the vehicle support structure 1. As mentioned above, the lower pins 22 of the condenser 2 and the lower condenser brackets 4 are configured and arranged to be releasably coupled together without using a fastening tool.

More specifically, each of the lower condenser brackets 4 preferably includes a retaining bore 4a formed in a center portion thereof as seen in FIGS. 2 and 3. The retaining bore 4a of the lower condenser bracket 4 is configured and arranged to receive the respective lower pin 22 of the condenser 2 while the flange 22a of the lower pin 22 abuts against a peripheral surface around the retaining bore 4a as seen in FIG. 3. Moreover, the lower condenser brackets 4 and the lower pins 22 are preferably configured and arranged to provide sufficient play therebetween so that the lower pins 22 can be slide in the retaining bores 4a of the lower condenser brackets 4 prior to the upper pins 21 are coupled to the upper condenser brackets 3. In an alternative embodiment, a rubber bushing or the like may be provided between the lower pin 22 and the lower condenser bracket 4.

Accordingly, when the lower pins 22 of the condenser 2 are inserted into the retaining bores 4a of the lower condenser brackets 4, the lower condenser brackets 4 are configured and arranged to substantially restrict a horizontal movement of the condenser 2 with respect to the vehicle support structure 1. However, the lower condenser brackets 4 are configured and arranged to permit an upward vertical movement of the condenser 2 when the upper pins 21 of the condenser 2 are disengaged from the upper condenser brackets 3.

In this embodiment of the present invention, the lower condenser brackets 4 are preferably made of metallic material such as steel, and integrally formed with the lower bolster member 14 of the vehicle support structure 1. More specifically, in this embodiment of the present invention, the lower condenser brackets 4 are stamped or molded integrally with the lower bolster member 14 so that the lower condenser brackets 4 and the lower bolster member 14 form a one-piece, unitary member as seen in FIG. 3. Moreover, precise structures of the lower condenser brackets 4 and the lower bolster member 14 are not limited to the ones illustrated in this embodiment of the present invention. Rather, any structure of the lower condenser bracket 4 can be adapted to carry out the present invention as long as the lower condenser brackets 4 are configured and arranged to form toolless connections with the lower pins 22 of the condenser 2. For example, the lower condenser brackets 4 can be provided within the lower bolster member 14 by forming the retaining bores 4a on the top surface of the lower bolster member 14. Of course, it will be apparent to those skilled in the art from this disclosure that the lower condenser brackets 4 can be formed as a separate member from the lower bolster member 14 as long as the lower condenser brackets 4 are fixedly coupled to the lower bolster member 14. Moreover, the lower condenser brackets 4 are not limited to be made of metal. The lower condenser brackets 4 can be made of composite material or plastic as long as the lower condenser brackets 4 are fixedly coupled to the lower bolster member 14.

As seen in FIGS. 3 to 6, each of the upper condenser brackets 3 are configured and arranged to allow the corresponding upper pin 21 of the condenser 2 to snap-fit into the upper condenser bracket 3. Moreover, the upper condenser brackets 3 and the upper pins 21 of the condenser 2 are configured and arranged to restrict both vertical and horizontal movements of the condenser 2 with respect to the vehicle support structure 1 when the upper pins 21 are coupled to the upper condenser brackets 3.

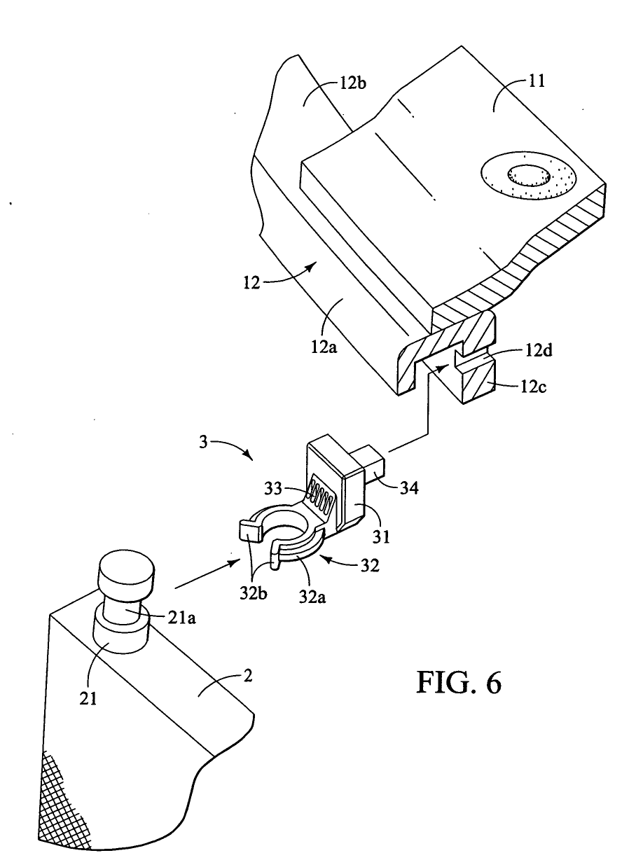

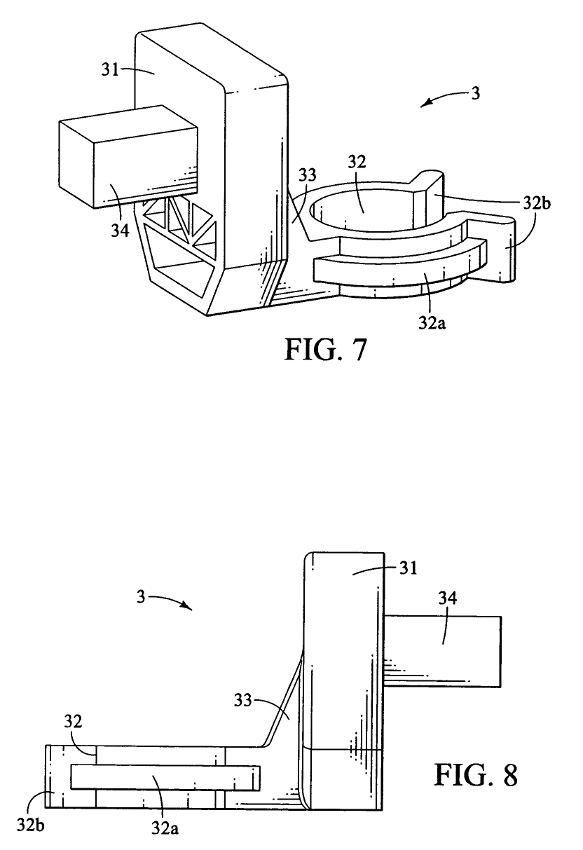

Referring now to FIGS. 6 to 8, one example of the structure of the upper condenser bracket 3 will be explained in detail. As seen in FIGS. 6 to 8, each of the upper condenser brackets 3 includes a base portion 31, a clip portion 32, a reinforcement rib 33 and a mounting portion 34. The base portion 31 of the upper condenser bracket 3 is configured and arranged to engage with the rear vertical part 12c of the upper bolster member 12 and to extend substantially in the vertical direction of the vehicle when the upper condenser bracket 3 is attached to the upper bolster member 12. The clip portion 32 of the upper condenser bracket 3 is configured and arranged to extend generally horizontally from the base portion 31 toward the front side of the vehicle when the upper condenser bracket 3 is attached to the upper bolster member 12. The clip portion 32 is formed as a substantially C-shaped member with a pair of free ends extending toward each other in the front side of the vehicle. The clip portion 32 is configured and arranged to snap-fit with the engagement groove 21a formed in the upper pin 21 of the condenser 2 and to retain the upper pin 21 of the condenser 2 therein. The clip portion 32 preferably includes a reinforcement flange 32a that extends radially from an outer circumferential surface of the clip portion 32, and a pair of lip portions 32b disposed at the free ends of the clip portion 32 as seen in FIGS. 6 and 7. The reinforcement rib 33 is disposed between the base portion 31 and the clip portion 32 to increase the structural stability of the upper condenser bracket 3. The mounting portion 34 is configured and arranged to extend horizontally toward the rear side of the vehicle from the base portion 31.

In this embodiment of the present invention, the upper condenser brackets 3 are preferably made of metallic material such as steel. Of course, it will be apparent to those skilled in the art from this disclosure that the upper condenser brackets 3 are not limited to be made of metallic material, but rather, the upper condenser brackets 3 can be made of composite material, plastic, or any other suitable materials. Moreover, it will be apparent to those skilled in the art from this disclosure that the precise structure of the upper condenser bracket 3 can vary depending on various design considerations of the vehicle including but not limited to the structures of the upper bolster member 12 and the upper pin 21 of the condenser 2.

Referring back to FIGS. 3 to 6, each of the upper condenser brackets 3 is fixedly coupled to the upper bolster member 12 of the vehicle support structure 1. More specifically, the mounting portion 34 of each of the upper condenser brackets 3 is inserted in a bracket receiving portion 12d formed in the rear vertical part 12c, and the upper condenser bracket 3 is preferably fixedly coupled to the bolster member 12 using spot weld or the like. Alternatively, when the upper bolster member 12 is made of composite material (or as hybrid), the upper condenser brackets 3 can also be made of plastic or composite material so that the upper condenser brackets 3 are integrally formed or molded together with the upper bolster member 12. It will be apparent to those skilled in the art from this disclosure that the material used for the upper condenser brackets 3 can be changed depending on the material used for the upper bolster member 12 or other considerations. Any material can be utilized for the upper condenser brackets 3 as long as the upper condenser brackets 3 have sufficient structural stability, and as long as the upper condenser brackets 3 are fixedly coupled to the upper bolster member 12 before the condenser 2 is attached to the upper condenser brackets 3. Moreover, any method of fixedly coupling the upper condenser brackets 3 to the upper bolster member 12 (e.g., weld, mold, bolt, snap-fit, etc.) can be selected to mount the upper condenser brackets 3 to the upper bolter member 12 depending on the materials and the structures of the upper bolster member 12 and the upper condenser brackets 3.

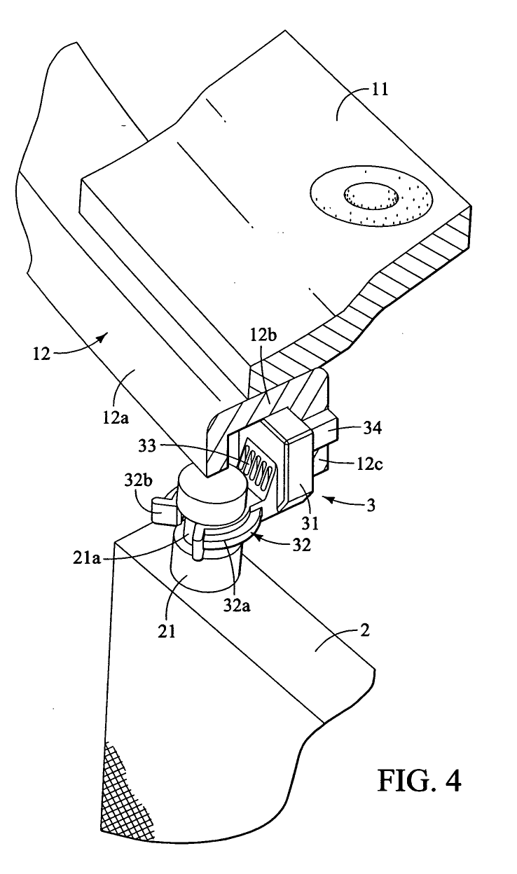

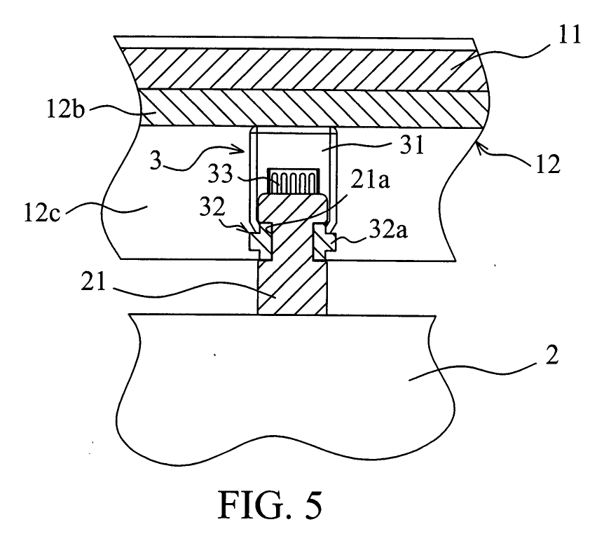

As seen in FIGS. 4 and 5, the clip portion 32 of the upper condenser bracket 3 is configured and arranged to snap-fit with the engagement groove 21a formed in the upper pin 21 of the condenser 2.

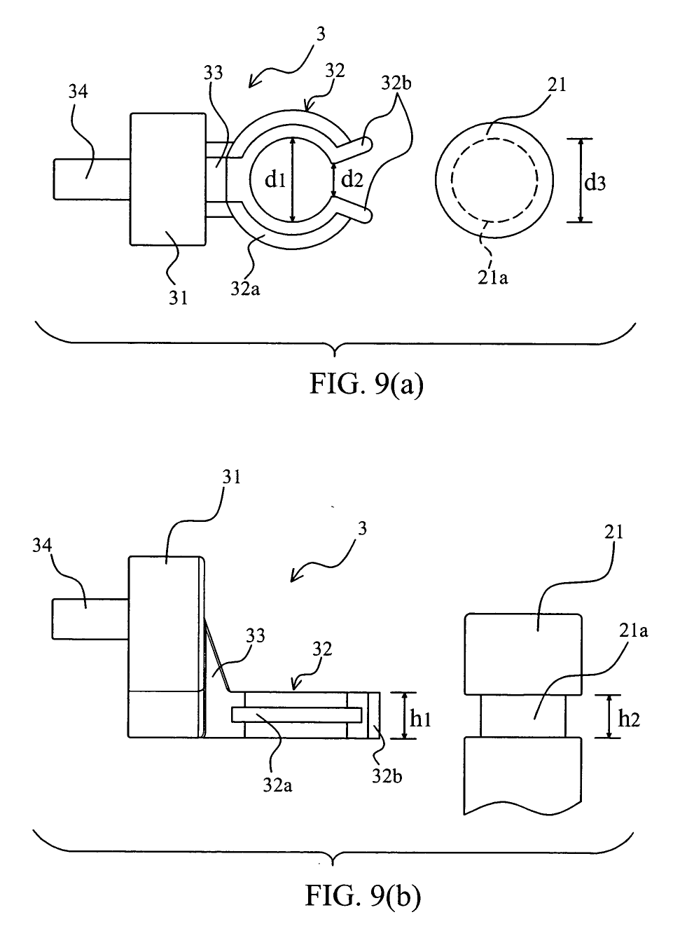

More specifically, as seen in FIG. 9(a), the upper condenser bracket 3 and the upper pin 21 of the condenser 2 are configured and arranged such that an inner diameter d1 of the clip portion 32 of the upper condenser bracket 3 is substantially equal to or slightly bigger than a diameter d3 of the engagement groove 21a formed in the upper pin 21. Moreover, the clip portion 32 is configured and arranged such that a minimum distance d2 between the lip portions 32b formed at the free ends of the clip portion 32 is smaller than the diameter d3 of the engagement groove 21a. The minimum distance d2 between the lip portions 32b and the diameter d3 of the engagement groove 21a are set so that the upper pin 21 snap-fits in the clip portion 32 of the upper condenser bracket 3, but the upper pin 21 is retained in position with respect to the upper condenser bracket 3 unless an external force is applied to detach the upper pin 21 from the upper condenser bracket 3. In other words, once the upper pin 21 is snap-fitted into the clip portion 32 of the upper condenser bracket 3, the inner circumferential surface of the clip portion 32 is configured and arranged to be closely fitted with the engagement groove 21a of the upper pin 21. The upper pin 21 can be detached from the upper condenser bracket 3 by pulling the upper pin 21 toward the front side of the vehicle.

Moreover, the engagement groove 21a of the upper pin 21 and the clip portion 32 of the upper condenser bracket 3 are configured and arranged so that both horizontal and vertical movements of the condenser 2 with respect to the vehicle support structure 1 are restricted when the upper pin 21 is attached to the upper condenser bracket 3. In other words, as seen in FIG. 9(b), the clip portion 32 of the upper condenser bracket 3 preferably has a vertical height h1 that is substantially equal to or slightly smaller than a vertical height h2 of the engagement groove 21a of the upper pin 21. Thus, when the upper pin 21 is snap-fitted into the clip portion 32 of the upper condenser bracket 3, upper and lower surfaces of the clip portion 32 are closely disposed with upper and lower surfaces of the engagement groove 21a, respectively, as seen in FIG. 5. Therefore, the vertical movement as well as the horizontal movement of the condenser 2 with respect to the vehicle support structure 1 is effectively restricted when the upper pins 21 are snap-fitted into the upper condenser brackets 3.

It will be apparent to those skilled in the art from this disclosure that precise structures of the upper pin 21 and the upper condenser bracket 3 are not limited to the ones illustrated in this embodiment of the present invention. The upper condenser bracket 3 and the upper pin 21 can be configured and arranged to have any structures or designs as long as the upper condenser bracket 3 and the upper pin 21 form a toolless connection therebetween which restricts both vertical and horizontal movements of the condenser 2 with respect to the vehicle support structure 1 when the upper pin 21 is attached to the upper condenser bracket 3. For example, the engagement groove 21a may be omitted from the upper pin 21 of the condenser 2 when the upper condenser bracket 3 is disposed with respect to the condenser 2 such that a bottom surface of the clip portion 32 directly abuts against the top surface of the condenser 2 when the upper pin 21 is attached to the upper condenser bracket 3.

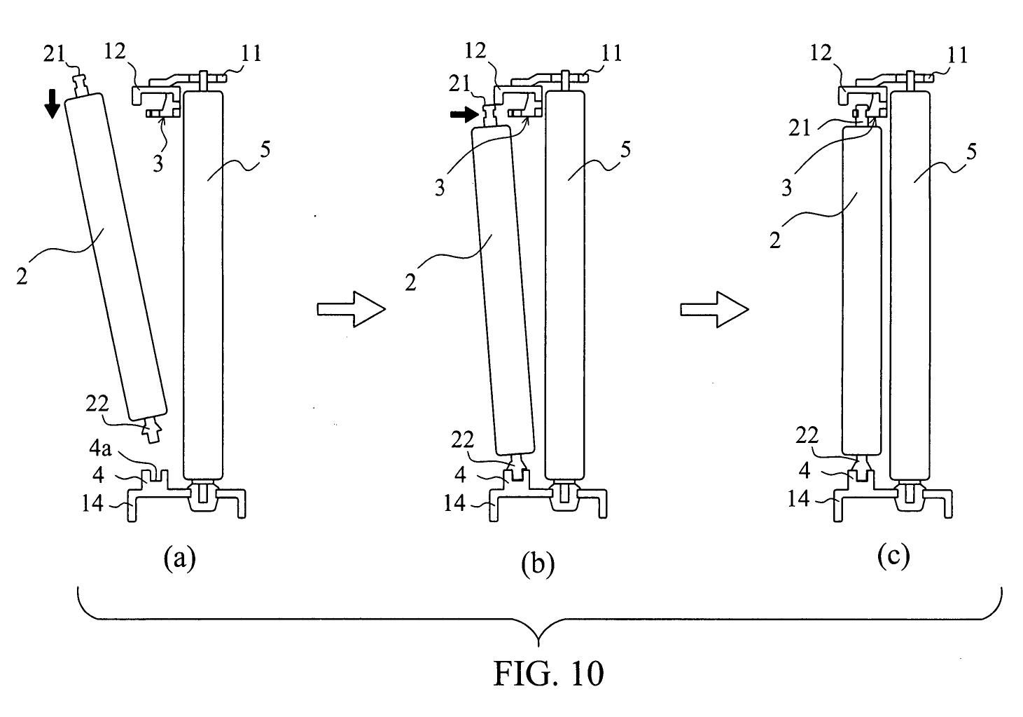

FIG. 10 shows a series of diagrams (a) to (b) for illustrating an assembly process of the condenser 2 to the vehicle support structure 1. As seen in the diagram (a) of FIG. 10, prior to mounting of the condenser 2 to the vehicle support structure 1, the upper condenser brackets 3 (only one shown in FIG. 10) and the lower condenser brackets 4 (only one shown in FIG. 10) are fixedly coupled to the upper bolster member 12 and the lower bolster member 14, respectively. In this embodiment of the present invention, as explained above, the lower condenser brackets 4 are preferably stamped or molded together with the lower bolster member 14, and the upper condenser brackets 3 are preferably attached to the upper bolster member 12 by using spot weld.

As seen in the diagram (a) of FIG. 10, the condenser 2 is first installed in a generally vertical direction (indicated by an arrow) with respect to the vehicle support structure 1 so that the lower pins 22 of the condenser 2 are inserted into the retaining bores 4a of the lower condenser brackets 4. As seen in the diagram (b) of FIG. 10, once the lower pins 22 are placed in the retaining bores 4a of the lower condenser brackets 4, the condenser 2 is tilted or rotated about the lower pins 22 in the rearward direction (indicated by an arrow) so that the upper pins 21 of the condenser 2 are moved toward the upper condenser brackets 3. Finally, the upper pins 21 are snap-fitted into the upper condenser brackets 3 so that the engagement grooves 21a of the upper pins 21 are tightly engaged with the clip portions 32 of the upper condenser brackets 3. As a result, the condenser 2 is non-movably mounted to the vehicle support structure 1 by the toolless connections formed between the upper condenser brackets 3 and the upper pins 21 of the condenser 2 and between the lower condenser brackets 4 and the lower pins 22 of the condenser 2, as seen in the diagram (c) of FIG. 10.

Moreover, the condenser 2 can be easily and quickly dismantled from the vehicle support structure 1 for services or the like without using a fastening tool by performing the process shown in the diagrams (a) to (c) of FIG. 10 in a reverse order. In other words, the upper condenser brackets 3 do not have to be removed to detach the condenser 2 from the vehicle support structure 1.

Accordingly, with the condenser arrangement in accordance with the present invention, the assembly time of the condenser 2 and the vehicle support structure 1 can be reduced because the condenser 2 can be easily and quickly mounted to the vehicle support structure 1 without using any fastening tools. Similarly, time required for disassembly and reassembly of the condenser 2 and the vehicle support structure 1 for services or the like can be reduced. Since the upper condenser brackets 3 do not have to be removed to detach the condenser 2 from the vehicle support structure 1, the upper condenser brackets 3 can be fixedly coupled or integrally formed with the vehicle support structure 1 prior to the condenser 2 is mounted to the vehicle support structure 1. When the upper condenser brackets 3 are spot welded to or molded together with the upper bolster member 12, the need for the additional fasteners for coupling the upper condenser brackets 3 to the upper bolster member 12 can be eliminated. As a result, risk of imparting incorrect torque to the upper condenser brackets 3 during assembly can be reduced, and thus, the assembly process of the condenser 2 to the vehicle support structure 1 can be performed more consistently. Furthermore, when the upper condenser brackets 3 are integrally formed with the upper bolster member 12, more design flexibility can be obtained for the front end portion of the vehicle, and the possibility of interferences between the upper condenser brackets 3 and the radiator 5 or any other components in that area can be eliminated.

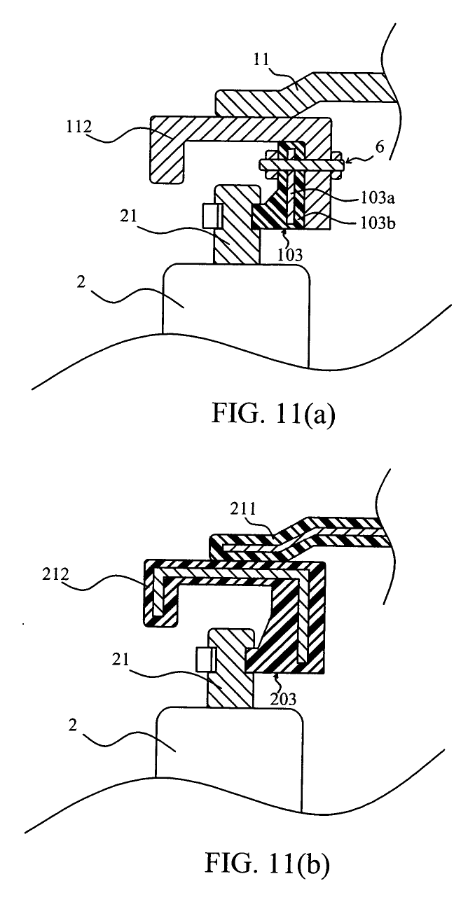

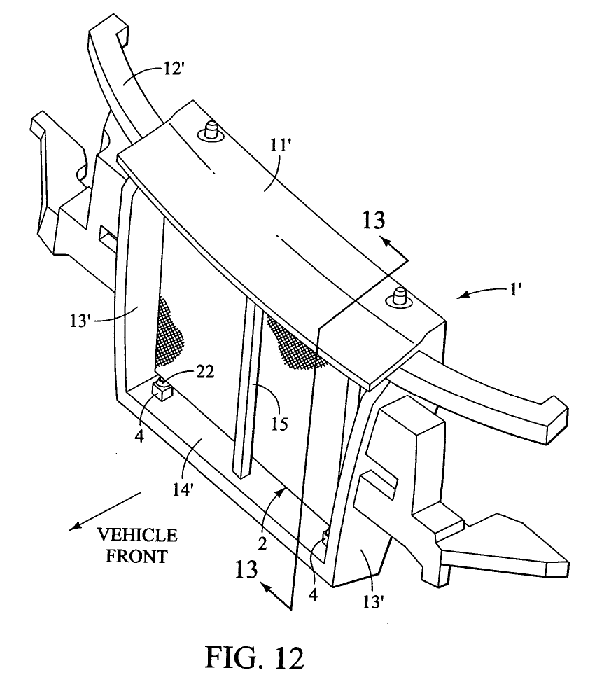

FIGS. 11(a) and 11(b) illustrate alternative structures of the condenser arrangement in which the upper condenser bracket 3 and the upper bolster member 12 in the above explained embodiment are modified. The only differences between the above explained embodiment and the alternative structures illustrated in FIGS. 11(a) and 11(b) are the materials used for the upper condenser bracket 3 and/or the upper bolster member 12 and the method of fixedly coupling the upper condenser bracket 3 and the upper bolster member 12. In other words, other parts and structures in the alternative embodiments illustrated in FIGS. 11(a) and 11(b) are identical to the parts and structures of the embodiment explained above.

More specifically, the upper condenser bracket 3 and the upper bolster member 12 can be substituted by an upper condenser bracket 103 and an upper bolster member 112 as seen in FIG. 11(a). In this modified embodiment, the upper condenser bracket 103 is made of composite material with a metal reinforcement member 103a and a molded plastic member 103b. The upper bolster member 112 is made of metal as the upper bolster member 12 of the above explained embodiment. In such case, the upper condenser bracket 103 is preferably fixedly coupled to the upper bolster member 112 by a fastening structure 6 (e.g., bolt and nut) as seen in FIG. 11(a).

On the other hand, FIG. 11(b) illustrates a case in which the upper bolster member 12 is substituted with an upper bolster member 212 which is made of composite material (with a metal reinforcement member and outer plastic member). In such a case, an upper condenser bracket 203 can be molded with the upper bolster member 212 to form a one-piece, unitary member as shown in FIG. 11(b).

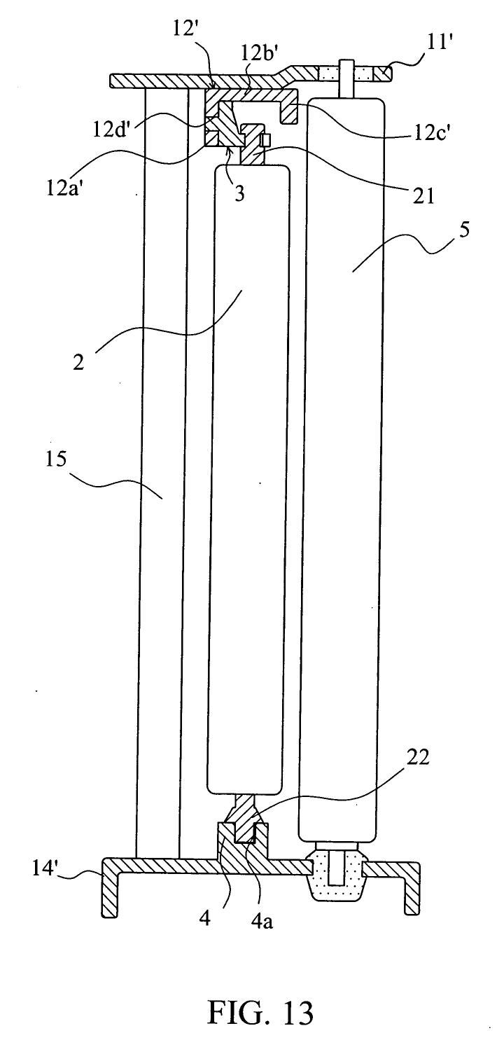

Referring now to FIGS. 12 and 13, a condenser arrangement in accordance with another embodiment will now be explained. In view of the similarity between this embodiment and the first embodiment, the parts of this embodiment that are identical to the parts of the first embodiment will be given the same reference numerals as the parts of the first embodiment. Moreover, the descriptions of the parts of this embodiment that are identical to the parts of the first embodiment may be omitted for the sake of brevity. The parts of this embodiment that differ from the parts of the first embodiment will be indicated with a single prime (′).

The condenser arrangement of this embodiment is basically identical to the condenser arrangement of the first embodiment explained above, except that the condenser 2 is mounted to a vehicle support structure 1′ as seen in FIG. 12 instead of the vehicle support structure 1 in the first embodiment. More specifically, the vehicle support structure 1′ differs from the vehicle support structure 1 of the first embodiment in that the vehicle support structure 1′ includes a vertical support member 15 that is disposed in a front center portion of an enclosed frame structure formed by an upper radiator bracket 11′, an upper bolster member 12′, a pair of side frame members 13′ and a lower bolster member 14′. The vertical support structure 15 is configured and arranged to reinforce a structural stability of the vehicle support structure 1′. Thus, the condenser arrangement in accordance with this embodiment, the condenser 2 is installed in or disassembled from the vehicle support structure 1′ from the rear side of the vehicle when the radiator 5 is detached from the vehicle support structure 1′.

Similarly to the first embodiment, the condenser 2 is preferably mounted to the vehicle support structure 1′ using two upper condenser brackets 3 and two lower condenser brackets 4 such that the toolless connections are formed between the upper and lower pins 21 and 22 of the condenser 2 and the upper and lower condenser brackets 3 and 4, respectively. These toolless connections can be constructed as in first embodiment or as shown in FIGS. 11(a) and 11(b).

When the vehicle support structure 1′ is provided with the vertical support member 15 as shown in FIG. 12, the condenser 2 is preferably mounted to the vehicle support structure 1′ from the rear side of the vehicle prior to the radiator 5 is installed during assembly. Therefore, in this embodiment of the present invention, each of the upper condenser brackets 3 are preferably fixedly coupled to the upper bolster member 12′ so that the base portion 31 of the upper condenser bracket 3 is disposed in the front side of the vehicle with respect to the clip portion 32 of the upper condenser bracket 3 as shown in FIG. 13. In other words, the mounting portion 34 of the upper condenser bracket 3 is inserted in a bracket receiving portion 12d′ formed in a front vertical part 12a′ of the upper bolster member 12′. In this embodiment of the present invention, a rear vertical part 12c′ of the upper bolster member 12′ is configured and arranged with respect to the upper bolster brackets 3 so that the rear vertical part 12c′ does not interfere with the upper pins 21 of the condenser 2 when the upper pins 21 are attached to or disengaged from the upper bolster brackets 3.

Accordingly, in the condenser arrangement in accordance with this embodiment, the condenser 2 is mounted to or dismantled from the vehicle support structure 1′ from the rear side of the vehicle while the radiator 5 is detached from the vehicle support structure 1′. In other words, when the condenser 2 is mounted to the vehicle support structure 1′ during assembly, first the upper condenser brackets 3 and the lower condenser brackets 4 are fixedly coupled to the vehicle support structure 1′. Similarly to the first embodiment, the lower condenser brackets 4 are preferably integrally formed with the lower bolster member 14′ as seen in FIG. 13. Then, the condenser 2 is installed from the rear side of the vehicle with respect to the vehicle support structure 1′ in a generally vertical direction so that the lower pins 22 of the condenser 2 are inserted into the retaining bores 4a of the lower condenser brackets 4. Once the lower pins 22 are placed in the retaining bores 4a of the lower condenser brackets 4, the condenser 2 is tilted or rotated about the lower pins 22 in the forward direction so that the upper pins 21 of the condenser 2 are moved toward the upper condenser brackets 3. Finally, the upper pins 21 are snap-fitted into the upper condenser brackets 3 so that the engagement grooves 21a of the upper pins 21 are tightly engaged with the clip portions 32 of the upper condenser brackets 3. As a result, the condenser 2 is non-movably mounted to the vehicle support structure 1′ by the toolless connections formed between the upper condenser brackets 3 and the upper pins 21 of the condenser 2 and between the lower condenser brackets 4 and the lower pins 22 of the condenser 2. The radiator 5 is then installed in the vehicle support structure 1′ as seen in FIG. 13.

Moreover, the condenser 2 can be easily and quickly dismantled from the vehicle support structure 1′ for services or the like without using a fastening tool by performing the process described above in a reverse order after the radiator 5 is detached from the vehicle support structure 1′. In other words, the upper condenser brackets 3 do not have to be removed to detach the condenser 2 from the vehicle support structure 1′.

Thus, substantially same effects obtained with the condenser arrangement of the first embodiment can also be attained with the condenser arrangement in accordance with this embodiment of the present invention as shown in FIGS. 12 and 13.

It will be apparent to those skilled in the art from this disclosure that the materials and the coupling structure of the upper condenser brackets 3 and the upper bolster member 12′ in this embodiment can be modified as explained above with referring to FIGS. 11(a) and 11(b).

Although, in the above explained embodiments, the condenser 2 is mounted to the vehicle support structure 1 or 1′ that is part of the vehicle front end module, the condenser arrangement of the present invention is not limited to such structure. For example, the upper condenser brackets 3 and the lower condenser brackets 4 can be fixedly coupled to other vehicle frame or body members, which are not part of a vehicle front end module, so that the condenser 2 is releasably coupled to those members without a fastening tool.

As used herein to describe the above embodiment(s), the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A vehicle supporting arrangement comprising:
a vehicle support structure with a bottom mounting portion and an upper mounting portion;
a lower condenser coupling structure fixedly coupled to the bottom mounting portion of the vehicle support structure;
an upper condenser coupling structure fixedly coupled to the upper mounting portion of the vehicle support structure;
a condenser having a lower attachment structure disposed at a bottom portion of the condenser that is releasably engaged with the lower condenser coupling structure of the vehicle support structure, and an upper attachment structure disposed at an upper portion of the condenser that is releasably engaged with the upper condenser coupling structure of the vehicle support structure, the upper and lower condenser coupling structures being configured and arranged with respect to the upper and lower attachment structures, respectively, to form a pair of toolless connections between the condenser and the vehicle support structure for repeatable connection and detachment of the condenser to and from the vehicle support structure with the toolless connections having retaining forces greater than vibrationally inducing forces occurring during operation of the vehicle; and
a radiator coupled to the vehicle support structure with a non-snap-fit arrangement.

2. The vehicle supporting arrangement as recited in claim 1, wherein
at least one of the toolless connections between the condenser and the vehicle support structure is configured and arranged to restrict both vertical and horizontal movements of the condenser with respect to the vehicle support structure when the condenser is coupled to the vehicle support structure.

3. The vehicle supporting arrangement as recited in claim 1, wherein
the upper attachment structure of the condenser and the upper condenser coupling structure of the vehicle support structure are configured and arranged to restrict both vertical and horizontal movements of the condenser with respect to the vehicle support structure when the condenser is coupled to the vehicle support structure.

4. The vehicle supporting arrangement as recited in claim 1, wherein
the upper condenser coupling structure of the vehicle support structure includes at least one upper bracket configured and arranged such that the upper attachment structure of the condenser is snap-fitted into the upper bracket to form the toolless connection.

5. The vehicle supporting arrangement as recited in claim 4, wherein
the upper bracket is further configured and arranged to retain the upper attachment structure of the condenser to prevent both vertical and horizontal movements of the condenser with respect to the vehicle support structure when the upper attachment structure of the condenser is snap-fitted into the upper bracket.

6. The vehicle supporting arrangement as recited in claim 5, wherein
the lower condenser coupling structure of the vehicle support structure includes at least one lower bracket configured and arranged such that the lower attachment structure of the condenser is movably supported in the lower bracket before the upper attachment structure of the condenser is snap-fitted into the upper bracket.

7. The vehicle supporting arrangement as recited in claim 1, wherein
the upper condenser coupling structure of the vehicle support structure includes a pair of upper brackets that are spaced apart in a transverse direction of the vehicle support structure, with the upper brackets being configured and arranged to secure the upper attachment structure of the condenser by a snap-fit.

8. The vehicle supporting arrangement as recited in claim 7, wherein
the lower condenser coupling structure of the vehicle support structure includes a pair of lower brackets that are spaced apart in a transverse direction of the vehicle support structure, with the lower brackets being configured to support the lower attachment structure of the condenser to restrain horizontal movement of the condenser while permitting upward vertical movement when the upper brackets are disengaged from the upper attachment structure of the condenser.

9. The vehicle supporting arrangement as recited in claim 1, wherein
the upper attachment structure of the condenser includes at least one pin portion, and
the upper condenser coupling structure includes at least one generally C-shaped clip portion coupled to the pin portion of the upper attachment structure of the condenser to form a snap-fit as the toolless connection therebetween.

10. The vehicle supporting arrangement as recited in claim 9, wherein
the pin portion of the upper attachment structure of the condenser includes an annular groove engaged with the clip portion of the upper condenser coupling structure to restrain both vertical and horizontal movements of the pin portion of the upper attachment structure of the condenser with respect to the clip portion of the upper condenser coupling structure.

11. The vehicle supporting arrangement as recited in claim 9, wherein
the lower attachment structure of the condenser includes at least one pin portion extending from the condenser in a substantially vertical direction, and
the lower condenser coupling structure includes at least one lower bracket with a retaining bore having the pin portion of the lower attachment structure inserted therein.

12. The vehicle supporting arrangement as recited in claim 1, wherein
the upper condenser coupling structure is formed with the upper mounting portion of the vehicle support structure as a one-piece, unitary member.

13. The vehicle supporting arrangement as recited in claim 12, wherein
the lower condenser coupling structure is formed with the lower mounting portion of the vehicle support structure as a one-piece, unitary member.

14. The vehicle supporting arrangement as recited in claim 1, wherein
the upper condenser coupling structure is fixedly coupled to the upper mounting portion of the vehicle support structure by using a fastening structure.

15. A method of detachably mounting a condenser and a radiator to a support structure of a vehicle, comprising:
installing one of an upper attachment part and a lower attachment part of the condenser to a first coupling structure of the support structure of the vehicle without using a fastening tool to couple a first portion of the condenser to the support structure;
installing one of the upper and lower attachment parts of the condenser that has not been coupled to the support structure to a second coupling structure of the support structure of the vehicle without using a fastening tool to couple a second portion of the condenser to the support structure such that a pair of toolless connections are formed between the condenser and the support structure for repeatable connection and detachment of the condenser to and from the support structure with the toolless connections having retaining forces greater than vibrationally inducing forces occurring during operation of the vehicle;
installing a radiator to the support structure with a non-snap-fit arrangement.

16. The method as recited in claim 15, wherein
the installing of the one of the upper attachment part and the lower attachment part of the condenser to the first coupling structure of the support structure is preformed by coupling the lower attachment part of the condenser with the first coupling structure of the support structure of the vehicle so that the lower attachment part is movable with respect to the first coupling structure of the support structure prior to the second portion of the condenser is coupled to the support structure.

17. The method as recited in claim 16, wherein
the installing of the one of the upper and lower attachment parts of the condenser to the second coupling structure of the support structure is performed by snap-fitting the upper attachment part of the condenser with the second coupling structure of the support structure so that the condenser is non-movably coupled to the support structure.

18. The method as recited in claim 15, wherein
the installing of the one of the upper attachment part and the lower attachment part of the condenser to the first coupling structure of the support structure is preformed by coupling the lower attachment part of the condenser with the first coupling structure of the support structure of the vehicle, and
the installing of the one of the upper and lower attachment parts of the condenser to the second coupling structure of the support structure is performed by coupling the upper attachment part of the condenser with the second coupling structure of the support structure after the lower attachment part of the condenser is coupled with the first coupling structure of the support structure of the vehicle.

19. The method as recited in claim 15, wherein
the installing of the one of the upper attachment part and the lower attachment part of the condenser to the first coupling structure of the support structure is preformed by inserting the lower attachment part of the condenser into the first coupling structure of the support structure of the vehicle in a generally vertical direction, and
the installing of the one of the upper and lower attachment parts of the condenser to the second coupling structure of the support structure is performed by
tilting the condenser about the lower attachment part of the condenser after the lower attachment part of the condenser is inserted into the first coupling structure of the support structure of the vehicle, and
engaging the upper attachment part of the condenser with the second coupling structure of the support structure.

20. The method as recited in claim 19, wherein
the engaging of the upper attachment part of the condenser with the second coupling structure of the support structure is performed by snap-fitting the upper attachment part of the condenser with the second coupling structure of the support structure.

21. The method as recited in claim 15, wherein
the installing of the one of the upper attachment part and the lower attachment part of the condenser includes installing the one of the upper attachment part and the lower attachment part of the condenser from a first side of the support structure, and
the installing of the radiator include installing the radiator from a second side of the support structure that is opposite from the first side.

22. The vehicle supporting arrangement as recited in claim 10, wherein
the annular groove of the pin portion of the condenser has a vertical height that is substantially equal to a vertical height of the clip portion of the upper condenser coupling structure.

23. The vehicle supporting arrangement as recited in claim 1, wherein
the vehicle support structure includes an upper bolster member and an upper radiator bracket fixedly coupled together and extending in a top portion of the vehicle support structure to form the upper mounting portion of the vehicle support structure, and
the upper condenser coupling structure is fixedly coupled to the upper bolster member and the radiator is coupled to the upper radiator bracket.

24. The vehicle supporting arrangement as recited in claim 1, wherein
the upper condenser coupling structure includes a plastic member having a metal reinforcement member therein.

25. The vehicle supporting arrangement as recited in claim 1, wherein
the lower condenser coupling structure is configured and arranged such that a bottom surface of the condenser is disposed higher than a bottom surface of the radiator as measured from the bottom mounting portion of the vehicle supporting structure.
